(19) United States
(12) Patent Application Publication
(10) Pub. No.: US 2009/0305828 A1
(43) Pub. Date: Dec. 10, 2009

(54) TRACTION MECHANISM DRIVE FOR AN INTERNAL COMBUSTION ENGINE

(75) Inventor: Thomas Rasche, Hessdorf (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/158,794

(22) PCT Filed: Nov. 30, 2006
(86) PCT No.: PCT/EP2006/069105

§ 371 Date: Aug. 27, 2008

(30) Foreign Application Priority Data
Dec. 24, 2005 (DE) 10 2005 062 318.2

(51) Int. Cl. F16H 55/36

(52) U.S. Cl. 474/94

(57) ABSTRACT

The invention relates to a traction mechanism drive for an internal combustion engine, comprising at least one drive pulley, at least one driven pulley, belt means which are embodied as a belt or chain, a tensioning element and a damping element. The invention is characterized in that at least one damping element is arranged on a driven or drive pulley and is embodied as a torsional vibration damper which comprises at least two sections which can be rotated against each other counter to the force of the energy accumulator and a friction element.

### FIELD OF THE INVENTION

The invention relates to a traction mechanism drive for an internal combustion engine, having at least one driving pulley, at least one driven pulley, a wraparound means which is embodied as a belt or chain, a tensioning element and a damping element.

### BACKGROUND OF THE INVENTION

In traction mechanism drives for internal combustion engine, there is often the problem that the traction mechanism drive can be incited to vibrate as a result of non-uniformities during the operation of the internal combustion engine. This can result in belt vibrations inter alia in the longitudinal or transverse direction. A separate damping element is therefore traditionally used in conventional traction mechanism drives, for example a mechanical or hydraulic belt or chain tensioner which converts mechanical vibrations into heat.

In order to prevent auxiliary units, for example a generator, from being adversely affected, it has already been proposed to decouple heavy rotating masses from the traction mechanism drive, for example by means of a generator freewheel. A generator freewheel is described in WO 2004/011818 A1 and is also referred to as an overrunning alternator decoupler (OAD). Here, however, a separate damping element must imperatively be provided in the traction mechanism drive, which increases the structural expenditure and costs.

DE 10 2005 008 381 A1 describes a vibration isolating, disk-shaped component which is of two-part design, with a radially inner region being fastened to the drive output shaft of the internal combustion engine and a radially outer region being used for torque transmission. With this component, it is possible for a plurality of moving parts of an internal combustion engine to be decoupled in terms of vibration.

DE 10 2004 011 829 A1 discloses a torsional vibration damper which comprises two parts which can be twisted counter to the resistance of two deformable energy store elements. The energy store elements can preferably be embodied as bow-shaped coil pressure springs.

### SUMMARY OF THE INVENTION

The invention is based on the object of creating a traction mechanism drive for an internal combustion engine in which vibrations are reliably dampened and which is of simple construction and is therefore cost-effective.

To solve said problem, in a traction mechanism drive for an internal combustion engine of the type specified in the introduction, it is provided according to the invention that the at least one damping element is arranged on a driven or driving pulley and is embodied as a torsional vibration damper which has at least two sections which are rotatable relative to one another counter to the force of an energy store and has a friction element.

The invention is based on the concept of eliminating non-uniformities by means of a torsional vibration damper which is arranged on a pulley instead of by means of a separate damping element or by means of a tensioning element which has a damping element. Accordingly, it is possible to use a tensioning element without a damper, which results in the desired simple construction of the traction mechanism drive according to the invention and therefore in cost savings. In the traction mechanism drive according to the invention, the damping function is performed by the torsional vibration damper, such that no vibrations are transmitted to the wraparound means and to the other components of the traction mechanism drive from the unit which is connected to the pulley which has the torsional vibration damper.

According to one preferred embodiment of the invention, it can be provided that the energy store comprises two bow springs which are each supported with their one end on a driver disk of the pulley and with their other end on a damper cage which serves as a slipping clutch The relative mobility of the two sections which are rotatable relative to one another results in the function of the slipping clutch; undesired vibration energy is converted into heat by means of the friction element.

In the traction mechanism drive according to the invention, the damping element can be arranged on a driven pulley which is connected to a generator or to a power steering pump or to a water pump or to an air-conditioning compressor or to some other unit; the damping element can preferably be arranged on the pulley of the generator, since the rotor of the generator usually has the largest rotating mass of all the units.

According to a further embodiment of the invention, it can be provided that the or a further damping element is arranged on a driving pulley which is connected to the crankshaft of the internal combustion engine. In said variant, non-uniformities are eliminated in the direct vicinity of their point of origin on the internal combustion engine.

In order to obtain a further structural simplification of the traction mechanism drive according to the invention, it can be provided that the tensioning element is embodied as an elastic belt. Here, the elastic belt itself serves as an elastic element; a separate tensioning element such as a spring tensioner or a hydraulic tensioner is not necessary. It is accordingly possible to dispense with the otherwise conventionally used separate mechanical or hydraulic tensioning element. The elastic belt used in said variant has a significantly greater degree of elasticity than conventional belts.

### BRIEF DESCRIPTION OF THE DRAWINGS

Further advantages and details of the invention can be gathered from the following description of an exemplary embodiment. In the figures:

FIG. 1 shows a schematic illustration of a traction mechanism drive according to the invention;

FIG. 2 shows a sectioned perspective view of a pulley which has a damping element; and

FIG. 3 shows a further exemplary embodiment of a traction mechanism drive according to the invention.

### DETAILED DESCRIPTION OF THE DRAWINGS

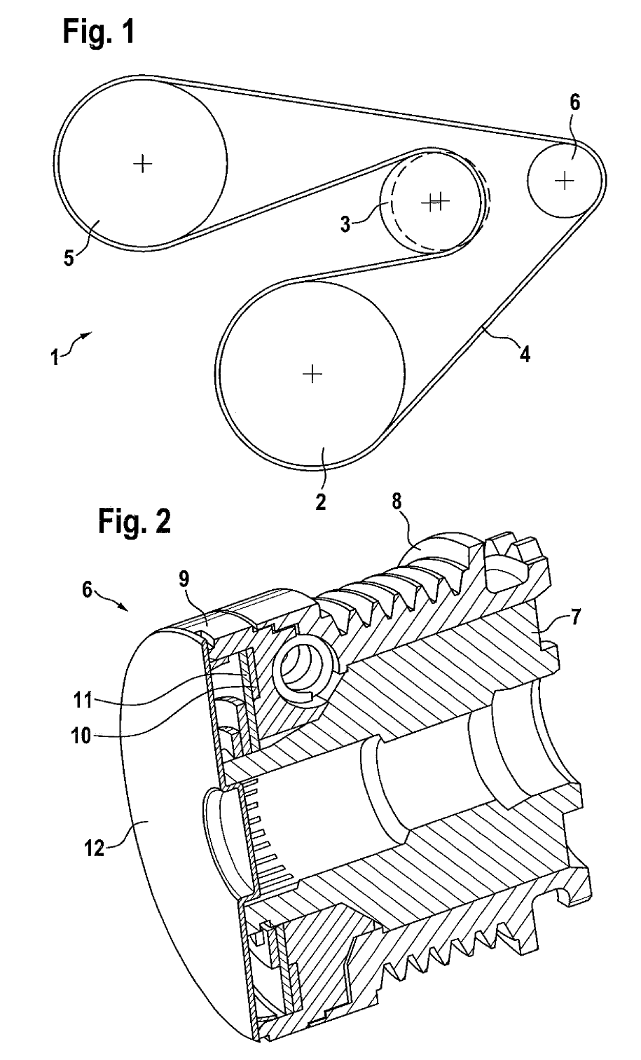

FIG. 1 shows a belt drive 1 in a schematic illustration. The belt drive 1 comprises a driving pulley 2 which is connected to the crankshaft of an internal combustion engine, and also a mechanical tensioning element which is embodied as a spring tensioner and which is connected to a tensioning roller 3. The tensioning roller 3 can be pivoted counter to the force of the spring, as indicated in FIG. 1 by the dashed-line illustration of the tensioning roller 3. The tensioning roller 3 ensures that there is a defined belt tension in the belt drive 1.

In the illustrated exemplary embodiment, the wraparound means is embodied as a belt 4. As further components, the belt drive 1 has a pulley 5 which, in this embodiment, is coupled to a water pump. It is possible for further auxiliary units such as a power steering pump, an oil pump or the like to be present in other embodiments of belt drives, which further auxiliary units each have driven pulleys.

A further pulley, referred to below as a driving disk 6, is coupled to a generator. The driving disk 6 has a damping element which prevents or at least largely excludes the transmission of vibrations from the generator to the belt 4. In order to prevent speed fluctuations or longitudinal vibrations of the belt 4 acting on the generator, the driving disk 6 is provided with a slipping clutch.

FIG. 2 shows an exemplary embodiment of a pulley or driving disk which has a damping element in a sectioned perspective view.

The driving disk 6 has already been described in detail in a different patent application; at this point, therefore, only the most important components are discussed where necessary for understanding.

The driving disk 6 comprises a hub 7 with an internal toothing which, in the installed state, is fixedly connected to the shaft of the generator. The hub 7 is surrounded by a driver disk 8; situated adjacent to the driver disk 8 in the axial direction is a damper cage 9 which serves as a slipping clutch and which has, in its interior, recesses for two bow springs, whose length in the tangential direction is slightly less than 180° each. A friction element which is embodied as a friction ring 10 bears against the damper cage 9, which friction element is acted on on its other side by a plate spring 11. A covering plate 12 seals the driving disk 6 to the outside. The function of the slipping clutch results from the relative rotation of the driver disk 8 with respect to the damper cage 9. The vibration damping and therefore the conversion of movement energy into heat energy is performed substantially by the friction ring 10 which is acted on continuously with the spring force of the plate spring 11 and which permanently imparts a damping torque.

The damping obtained in this way is so high that a separate damping element can be dispensed with in the belt drive 1; it is therefore sufficient to use a tensioning element without any particular damping properties.

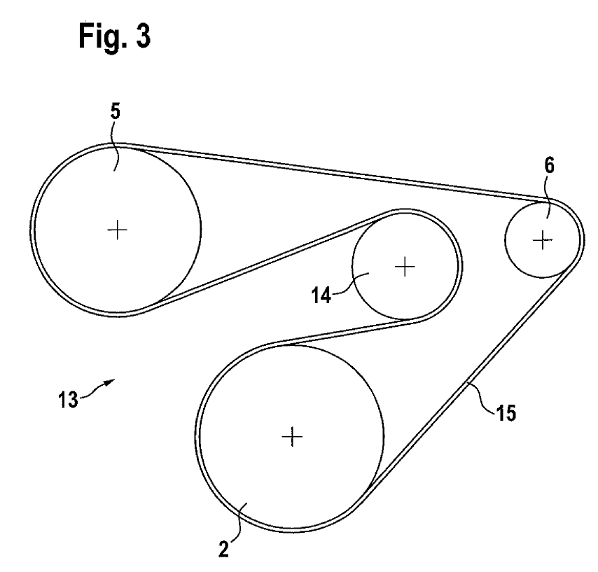

FIG. 3 shows a further exemplary embodiment of a traction mechanism drive according to the invention.

In correlation with the belt drive shown in FIG. 1, the belt drive 13 comprises a driving pulley 2, a pulley 5 which is coupled to an auxiliary unit and a driving disk 6. In contrast to the exemplary embodiment shown in FIG. 1, the belt drive 13 has a positionally fixed deflecting roller 14, that is to say said deflecting roller is not a tensioning roller. In said exemplary embodiment, the wraparound means is embodied as an elastic belt 15 which has a particularly high level of elasticity in relation to a conventional belt. The adherence to the defined belt force is thereby ensured to a great extent by the elastic belt 15, such that a separate tensioning roller or the like can be dispensed with. The damping of vibrations is ensured by the torsional vibration damper of the driving disk 6.

### LIST OF REFERENCE SYMBOLS

1 Belt drive

2 Pulley

3 Tensioning roller

4 Belt

5 Pulley

6 Driving disk

7 Hub

8 Driver disk

9 Damper cage

10 Friction ring

11 Plate spring

12 Cover plate

13 Belt drive

14 Deflecting roller

15 Elastic belt

1. A traction mechanism drive for an internal combustion engine, comprising: at least one driving pulley, at least one driven pulley, a wraparound means which is embodied as a belt or chain, a tensioning element and a damping element, wherein the at least one damping element is arranged on a driven or driving pulley and is embodied as a torsional vibration damper which has at least two sections which are rotatable relative to one another counter to the force of an energy store and has a friction element.

2. The traction mechanism drive as claimed in claim 1, wherein the energy store comprises two bow springs which are each supported with their one end on a driver disk of the pulley and with their other end on a damper cage which serves as a slipping clutch.

3. The traction mechanism drive as claimed in claim 1, wherein the damping element is arranged on a driven pulley or driving disk which is connected to a generator or to a power steering pump or to a water pump or to an air-conditioning compressor.

4. The traction mechanism drive as claimed in claim 1, wherein the or a further damping element is arranged on a driving pulley which is connected to the crankshaft of the internal combustion engine.

5. The traction mechanism drive as claimed in claim 1, wherein the tensioning element is embodied as an elastic belt.
